(19) United States
(12) Patent Application Publication
(10) Pub. No.: US 2003/0099437 A1
(43) Pub. Date: May 29, 2003

(54) Variable optical filter and devices applying such filter

(76) Inventors: Andre Pierre Persoons, Holsbeek (BE); Thierry Jules Johan Verbiest, Herent (BE)

Correspondence Address: Nixon & Vanderhye, 8th Floor, 1100 North Glebe Road, Arlington, VA, 22201-4714, US

(21) Appl. No.: 10/258,735

(22) PCT Filed: Apr. 26, 2001
(86) PCT No.: PCT/BE01/00073

(30) Foreign Application Priority Data
Apr. 26, 2000 (BE) 20000297

(51) Int. Cl. G02F 1/295; G02B 6/26; G02B 6/42

(52) U.S. Cl. 385/39; 385/10; 385/40

(57) ABSTRACT

Variable optical filter, at least consisting of an optical filter structure (2) with different zones (3A-3B-3C-3D-3E) and/or reflection surfaces (4A-4B-4C-4D-4E-4F) which are made such that light (L1) with a well-defined wavelength passes, whereas light (L2) with another wavelength is reflected, in particular according to the so-called Bragg principle, whereby this filter (1-1A-1B-1C) also is provided with means (7) for altering the optical characteristics of the filter structure (2), characterized in that the aforementioned means (7) at least consist in that, on one hand, the optical path of the aforementioned filter structure (2) comprises a portion (6) based on one or more polymers, which is configured as an optical cavity enclosed by refractive surfaces of the aforementioned filter structure, and the optical characteristics of which can be changed under the influence of an electric potential, an electric field (E), respectively, or under the influence of light and, on the other hand, the filter (1) is provided with means (7) with which, in a controlled manner, an electric potential can be generated over, respectively, an electric field (E) in the aforementioned portion (6), and/or an optical field in this portion.

This invention relates to an optical filter, more particularly an optical pass filter, as well as to devices applying such optical filter.

More particularly, the invention relates to a variable optical filter comprising at least an optical filter structure with various zones which are made such that light with a well-defined wavelength passes, whereas light with another wavelength is reflected, in particular according to the so-called Bragg principle.

There are already known various embodiments of optical filters, amongst which the aforementioned so-called Bragg filters. In these Bragg filters, use is made of a structure with successive zones with a different refractive index and/or different periodicity, in such a manner that when light with well-defined frequencies is sent therethrough, light with well-defined frequencies is reflected at the different transitions.

Depending on the arrangement, it is obtained that in a well-defined bandwidth only light of one or more well-defined frequencies passes, whereas the remaining light is reflected.

It is also known to exert an influence on and to control one of the zones and/or transitions, as a result of which the function of the filter becomes variable and, for example, can be controlled in order to provide in optical signal processing.

In this manner, it is namely possible to have light of well-defined frequencies pass in a systematic manner and, by multiplexing and demultiplexing, to transmit different signals through one optical fiber.

A known technique consists in designing one zone as an opening and in mechanically altering the distance over which this zone extends, by means of control using a piezoelectric crystal. Such mechanical control by means of a piezoelectric crystal, however, is relatively slow which in signal transmission, especially when a large quantity of information has to be transmitted per time unit through one and the same optical fiber, poses a major problem.

A number of other possibilities are described in the patent document WO 91/10156. Hereby, a specific embodiment is concerned whereby the Bragg filter is integrated into the optical fiber itself and whereby the optical path is not interrupted, however, a portion of material of the filter structure is influenced in such a manner that the refractive index or the periodicity of one of the zones of the Bragg filter is altered.

According to the aforementioned patent document, this can take place in different ways, amongst others also by applying an electric field. Inasmuch as use is made of an electric field, the latter is only applied for generating alterations in a coating around the optical fiber, as a result of which, in its turn, an acoustic field is generated in the material of the filter structure, whereby this acoustic field effects on the refractive index.

A disadvantage of the use of a piezo-electric crystal and of acoustic signals consists in that the systems based thereupon are too slow for efficient signal processing.

Another possibility is described in the patent document U.S. Pat. No. 4,057,321. Hereby, a specific embodiment is concerned whereby a flat wave conductor consisting of the electro-optical material lithiumniobate, provided on a glass substrate, is situated between two Bragg reflectors made of glass and over which an electric potential can be applied in order to alter the refractive index. A similar embodiment whereby an electric field is applied longitudinally in the film in order to alter the refractive index in the electro-optical material lithiumniobate, is also presented as a variable optical filter, to which aim reference is made to the patent document U.S. Pat. No. 4,039,249.

A disadvantage of the use of crystalline and/or anorganic electro-optical materials, such as lithiumniobate and analogous compounds, consists in that in the direction of an electric field applied transversally over the material, the electro-optical coefficients have a fixed, unalterable, low value and not their highest value. At the same time, the overall thickness of the required structure necessitates the application of high voltages in order to obtain sufficient alteration of the refractive index as necessary for the required applications. Moreover, these materials can be applied on the substrate by very complicated and expensive methods only and have no or little flexibility. Due to photo-refractive effects, they undergo non-reversible photodegradation during their use. Also, the optical features of these electro-optical crystalline and/or anorganic materials render their adaptation with the Bragg filter structure, made of another material, very difficult. This is, moreover, also the case for integration with other optical components such as optical fibers (mono- or multimode glass and/or polymer fibers).

The use of so-called “Bragg gratings” for multiplexing optical signals is known from WO 99/42893. According to this document, the actual Bragg structure is influenced, as a result of which there is little freedom for altering the features. Moreover, according to this known document the influencing substantially is realized by means of heat supply, which results in a slow working. Also, an electro-optical control is mentioned, however, without any information about how the electro-optical interaction is realized. Furthermore, the working of the structure described in said document is based on refraction, which results in a complex embodiment, as light with different frequencies has to be coupled out by means of elements provided especially to this end.

The invention aims at a variable optical filter which is improved in respect to the known embodiments and, more particularly, offers solutions to the aforementioned disadvantages.

To this aim, the invention relates to a variable optical filter, at least consisting of an optical filter structure with different zones and/or reflection surfaces which are made such that light with a well-defined wavelength is passed, whereas light with another wavelength is reflected, in particular according to the so-called Bragg principle, whereby this filter also is provided with means for altering the optical characteristics of the filter structure, with as a characteristic that the aforementioned means at least consist in that, on one hand, the optical path of the aforementioned filter structure comprises a portion based on one or more polymers, which portion is configured as an optical cavity which is enclosed by refractive surfaces of the aforementioned filter structure, and the optical characteristics of which can be changed under the influence of an electric potential, an electric field, respectively, or under the influence of light and, on the other hand, the filter is provided with means with which, in a controlled manner, an electric potential can be generated over, respectively, an electric field in the aforementioned portion, and/or an optical field in this portion.

By using a portion which, as aforementioned, is made on the basis of polymers, a filter can be constructed at relatively low costs, this contrary to the aforementioned known expensive techniques which are necessary with the materials applied up to now. In the case of a control by means of an electric field, it also becomes possible to work with low potentials, as a result of which the application of less expensive apparatus' for the control also becomes possible.

In that, moreover, use is made of an electric or optical field which directly controls a part of the optical path, a very efficient structure is obtained which can be controlled with very high switching frequencies, up to several gigahertz. The disadvantages of the slowness of the mechanical driving, as well as of an acoustic influence, therefore are excluded.

In this manner, a solution to each of the above-said disadvantages of the known systems is offered.

Preferably, the aforementioned portion is formed at least partially, but preferably entirely, of polymer material, more particularly a polymer material being applied on a substrate as an amorphous polymer film.

In the case of an electric actuation, preferably use shall be made of so-called electro-optical polymers.

These are polymers with good optical features to which an electro-optically active colorant is chemically bonded or in which an electro-optical colorant is dissolved with the optimum concentration. Also, copolymers can be applied. As a non-restrictive example of an electro-optical polymer, polymethylmethacrylate with the colorant disperse red (whether or not chemically bonded to the polymethylmethacrylate) has to be mentioned. The electro-optical characteristics finally are obtained by orienting the electro-optical polymer by means of a suitable orientation method, with the use of electric poles as a non-restrictive example.

The Bragg filter zones preferably shall be constructed from the same polymer, whereby zones are formed in the Bragg filter by means of exposure to UV or visible light.

Such electro-optical polymers namely offer the advantage that they have an refractive index which, for the intended applications, sufficiently variates in function of the applied potential, in function of the created electric field, respectively.

It is noted that liquid crystalline polymers and electro-optical materials based upon anorganic-organic hybrid materials (for example, with embedded anorganic materials), whereby as a non-restrictive example sol-gel material can be named, also can be applied, as well as light-sensitive polymers, either conjugated or not. Such conjugated polymers, also called photo-sensitive polymers, are polymers, the refractive index of which can be altered in a reversible manner under the influence of light of a well-defined frequency.

The means with which an electric field is generated, preferably consist of at least two electrodes which are provided at opposite sides of the aforementioned portion, respectively. Practically seen, the distance between the electrodes shall be of the order of magnitude of several dozens of microns or less. As a result thereof, the electric potential which is necessary for controlling the whole, can be kept limited to voltages as usual with electronic circuits and apparatus', in particular several volts or dozens of volts.

According to an important preferred characteristic of the invention, the aforementioned portion consists of a layer-shaped material, this contrary to the mostly applied embodiments of Bragg filters which are integrated into the optical fibers themselves. The layer-shaped structure can function as a flat light conductor or channel-shaped light conductor. However, a circular light conductor is not excluded, either. Due to such layer-shaped structure, the overall thickness, as aforementioned, can be chosen very small, as a result of which the aforementioned potential can be limited to a practical value. At the same time, such layer-shaped structure offers additional advantages, such as, amongst others, the easier application of electrodes, and the possibility of applying electric fields and signals.

Preferably, not only the portion which can be influenced by means of the electric field, but the entire filter structure, in other words, at least the aforementioned zones forming the actual Bragg filter, are realized of the same layer-shaped material. As a result thereof, the filter can very easily be integrated into complete optical structures, as the electro-optical portion of the filter structure and the Bragg filter show identical optical features.

A particularly practical structure is obtained when the layer-shaped material and possibly additional layers provided thereupon and/or beneath it, are formed by so-called spincoating. As a result thereof, in fact a particularly thin layer with smooth upper and lower surface is guaranteed. It has to be noted that not only spincoating, but also any other method for producing thin layer structures can be used for applying the layer-shaped material.

It is noted that the Bragg zones do not necessarily have to be made of the same polymer, but that the layer-shaped structure can also be removed locally, for example, milled off, whereby then another polymer is provided instead.

Of course, the invention can be used in a variety of applications. It is particularly useful, however, in devices which function als a multiplexer and/or demultiplexer for optical signals, as an optical signal generator, as an optical switch, or as a high-frequency optical modulator.

Further, the invention is also particularly suitable for application in transmission structures for telecommunications or in a transmission system for domotica or immotica applications.

With the intention of better showing the characteristics of the invention, hereafter, as an example without any limitative character, a preferred form of embodiment is described, with reference to the accompanying drawings, wherein:

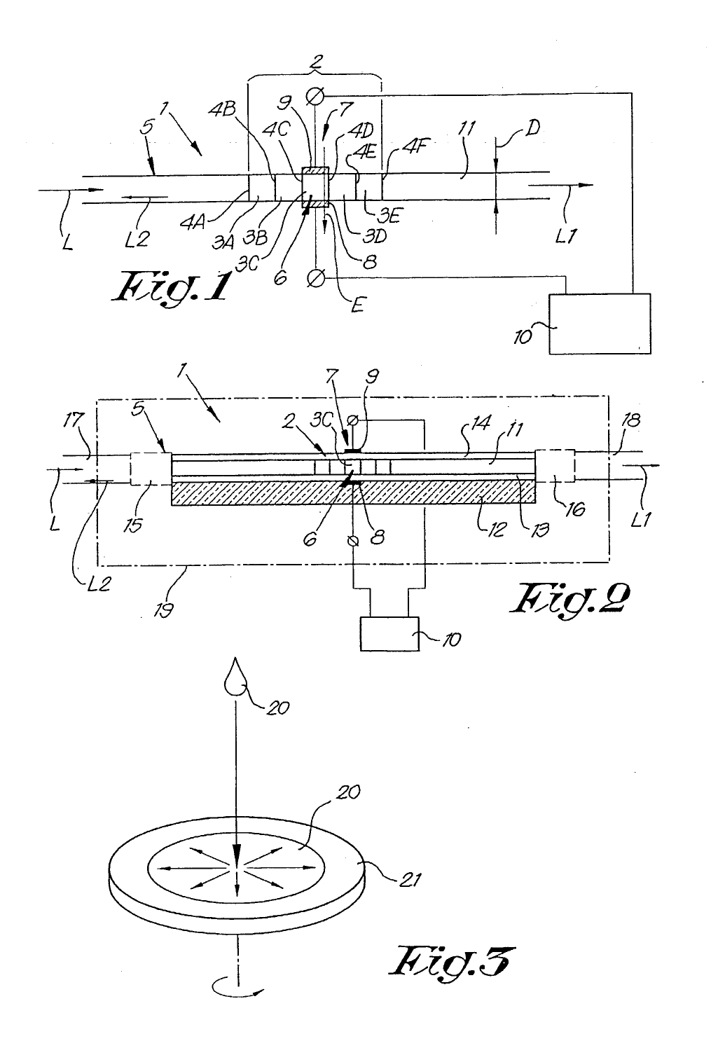

FIG. 1 schematically represents a variable optical filter according to the invention;

FIG. 2, in greater detail, represents a practical form of embodiment of an optical filter according to the invention;

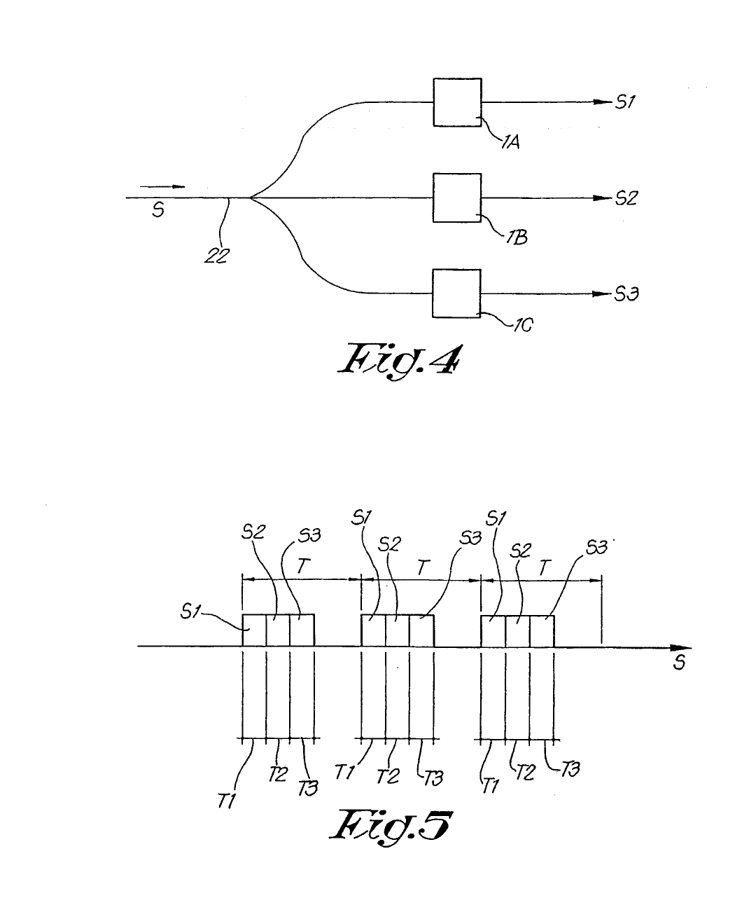

FIG. 3 schematically represents how a layer-shaped structure of the filter can be formed;

FIG. 4 schematically represents an application of filters according to the invention;

FIG. 5 represents a signal used in the application of FIG. 4.

As represented in FIG. 1, the optical filter 1 according to the invention has an optical filter structure 2 with various zones, in this case 3A to 3E, as a result of which different reflective surfaces 4A to 4F, also called grid surfaces, are formed, in such a manner that, when light L is supplied in at the entry 5 of the filter structure 2, light L1 with well-defined wavelengths passes, whereas light L2 with other wavelengths is reflected, this preferably according to the generally known principle of a Bragg filter. In consideration of the fact that this principle is sufficiently known in itself, it will not be explained in further detail.

According to the present invention, the filter 1 is provided with means for altering the optical features of the filter structure, which means at least consist in that, on one hand, the optical path of the aforementioned filter structure 2 comprises a portion 6, the optical features of which can be altered under the influence of an electric field E and, on the other hand, the filter 1 is provided with means 7 with which the aforementioned electric field E can be generated in the portion 6 in a controlled manner.

As schematically indicated, the aforementioned portion 6 preferably coincides with one of the aforementioned zones 3A to 3E, in this case the zone 3C. This zone 3C, however, does not form a part of the actual Bragg filter, but is constructed as an optical cavity provided in between the refractive surfaces or, thus, Bragg gratings, and therefore, so to speak, is closed off by Bragg mirrors. Hereby, it is noted that FIGS. 1 and 2 are only schematic and that in reality, on the left as well as on the right hand side of the zone 6 functioning as an optical cavity a large number of refractive surfaces or Bragg gratings are present, whereby in reality the length of zone 3C or, therefore, of the cavity is of the same order of magnitude or larger than the distances in between each of the successive Bragg grating periods.

The respective portion 6, and even better the entire filter structure 2, consist according to the invention of one or more polymeres or a structure based on one or more polymers, more particularly electro-optical polymers.

The aforementioned means 7 are formed, on one hand, electrodes 8 and 9 and, on the other hand, an electronic unit 10 for controlling the electric potential applied over the electrodes 8-9.

The distance D between the electrodes 8-9, which normally also shall coincide with the thickness of the filter structure 2, is, as already mentioned in the introduction, preferably of the order of magnitude of several dozens of microns or smaller.

The portion 6 and even better the entire filter structure 2 are preferably formed of a layer-shaped material, such that the distance D easily can be chosen relatively thin.

In FIG. 2, a more practical form of embodiment of the filter 1 from FIG. 1 is represented. Hiereby, the layer-shaped material layer 11, of which the filter structure 2 forms a part, is applied on a support layer or substrate 12, consisting of glass, quartz, silicium, synthetical diamond, or any other suitable material.

As represented, of course other layers can be provided, in this case a sublayer 13, as well as a top layer 14 which, for example, consist of an optical polymer which defines waveguiding, provides for a reduction of optical losses and offers optical and mechanical screening.

In the represented example, the electrodes 8 and 9 are provided under the sublayer 13 and on top of the top layer 14, respectively; however, it is clear that these may also be provided in other places. Both electrodes also can be used for orienting the electro-optical polymers by means of electric poling.

Further, the filter 1 from FIG. 2 is provided with an optical entry part 15, as well as an optical exit part 16, as a result of which a connection to optical fibers 17 and 18 is possible. Such entry and exit parts are sufficiently known in themselves from other applications and, therefore, will not be described in detail.

Finally, it is clear that the filter 1 preferably shall be build-in into a housing which is only schematically indicated by reference number 19. This housing 19 preferably is realized such that the filter structure 2 is protected against temperature influences. Possibly, also cooling means and/or other means for stabilizing the temperature can be provided.

The aforementioned material layer 11, and preferably also the sublayer 13 and the top layer 14, preferably consist of layers which are obtained by means of so-called spincoating. Spincoating is a technique known in itself, whereby, as represented schematically in FIG. 3, a quantity of material 20 is brought on the center of a substrate 21 and whereby, by rotating the substrate 21, this material 20, under the influence of the centrifugal force, is spread to a thin layer. In the invention, the substrate 21 shall consist of the aforementioned support layer 12. It is clear that this support layer 12 hereby can consist of a piece which is cut out of the substrate 21 after spincoating.

It is clear that, by controlling the potential over the electrodes 8-9, signal processing can be performed, whereby in the first place, multiplexing or demultiplexing of optical signals is intended, as well as generating pulsed optical signals.

In order to improve the filtering features, several filters, similar or identical to the variable optical filter 1, can be placed in series and applied on the same substrate.

For clearness' sake, in FIGS. 4 and 5, in a highly schematized manner, an application is represented for demultiplexing of a signal according to the TDM principle (Time Domain Multiplexing).

According to FIG. 4, hereby use is made of three filters 1A, 1B, and 1C according to the invention for deriving from a signal S, supplied by means of an optical fiber 22, three signals S1, S2, and S3, either amplified or not.

As represented in FIG. 5, the signal S is containing information which is transmitted periodically with a period T, whereby the different signals S1, S2, and S3, respectively, cover subperiods T1, T2, and T3.

In order to demultiplex the signal, in other words, to separate the signals S1, S2, and S3 therefrom, the signal S is fed to all three filters 1 and these are controlled in such a manner that the signal S during the subperiod T1 is let through at the first filter 1A, during the subperiod T2 at the second filter 1B, and during the subperiod T3 at the third filter 1C.

In reality, a very large number of signals per time unit can be processed, as, thanks to the invention, enormous control speeds are possible.

According to a variant, instead of TDM also ‘wavelength-multiplexing/demultiplexing’ can be performed by means of the filters according to the invention, whereby then simultaneously optical signals consisting of light with different wavelengths can be transmitted and the light with different wavelengths is separated by means of the respective filters.

Although the example described by means of the figures relates to an embodiment with electro-optical polymers, it is clear that instead thereof, one may also work with photo-sensitive polymers, such as explained in the introduction. The means 7 then do not consist of electrodes, but of an arrangement which allows that the photo-sensitive polymers can be irradiated with light in an appropriate manner, as a result of which, in doing so, the refractive index can be altered. Neither is a combination of an electric and optical control excluded.

It is noted that the invention is not limited to filters functioning according to the Bragg principle, but applies for each system whereby, by means of different zones and/or transitions with refractive surfaces, a filtering can be performed.

It is also noted that under the means 7 for altering the optical features, every form of elements, devices, systems and such has to be understood by which, by means of an electric potential and/or light, an alteration in the optical behaviour of the material itself can be achieved.

According to a preferred characteristic of the invention, use is made of means 7 with a portion 6 having the characteristic that the refractive index thereof changes linearly or almost linearly with the electric field, to which end, for example, oriented polymers, in other words, optically active groups having a preferred direction in space according to a polar order, are particularly suited. The use of such polymers reacting in a linear manner has as an advantage that, for the small electric fields which are applied in the present technical field, minor potential variations rapidly lead to considerable variations of the refractive index, which is not the case with non-oriented polymers, as the relation then is non-linear, but square and with small electric fields, an alteration in the value of the electric field hardly results in an alteration of the refractive index.

The present invention is in no way limited to the forms of embodiment described by way of example and represented in the figes, on the contrary, such variable optical filter, as well as the devices applying such filter, may be realized according to different variants without leaving the scope of the invention.

1. Variable optical filter, at least consisting of an optical filter structure (2) with different zones (3A-3B-3C-3D-3E) and/or reflection surfaces (4A-4B-4C-4D-4E-4F) which are made such that light (L1) with a well-defined wavelength passes, whereas light (L2) with another wavelength is reflected, in particular according to the so-called Bragg principle, whereby this filter (1-1A-1B-1C) also is provided with means (7) for altering the optical characteristics of the filter structure (2), characterized in that the aforementioned means (7) at least consist in that, on one hand, the optical path of the aforementioned filter structure (2) comprises a portion (6) based on one or more polymers, which is configured as an optical cavity enclosed by refractive surfaces of the aforementioned filter structure, and the optical characteristics of which can be changed under the influence of an electric potential, an electric field (E), respectively, or under the influence of light and, on the other hand, the filter (1) is provided with means (7) with which, in a controlled manner, an electric potential can be generated over, respectively, an electric field (E) in the aforementioned portion (6), and/or an optical field in this portion.

2. Variable optical filter according to claim 1, characterized in that the aforementioned portion (6) substantially coincides with one or more of the aforementioned zones (3A-3B-3C-3D-3E).

3. Variable optical filter according to claim 1 or 2, characterized in that the aforementioned portion (6) is formed at least partially of a polymer of a material based on polymer, chosen from the following series: an electro-optical polymer, liquid crystalline polymer, electro-optical material based on anorganic-organic hybride materials, sol-gel material, light-sensitive polymers, either or not conjugated, polymethylmethacrylate, polymethylmethacrylate to which an electro-optically active colorant is chemically bonded, pure polymethylmethacrylate wherein an electro-optical colorant is solved, and polycarbonates and co-polymers of polycarbonates.

4. Variable optical filter according to any of the preceding claims, characterized in that, in the embodiments whereby controlling takes place by means of an electric field (E), the means (7) with which an electric field (E) is generated comprise at least two electrodes (8-9) which are provided at opposite sides of the aforementioned portion (6), respectively.

5. Variable optical filter according to claim 4, characterized in that the distance (D) between the electrodes (8-9) is several dozens of microns or less.

6. Variable optical filter according to any of the claims 1 to 3, characterized in that, in the embodiments whereby controlling takes place by means of light, the means (7) consist of an arrangement which allows for that the optical path in the aforementioned portion (6) can be altered by illumination with light of appropriate wavelength.

7. Variable optical filter according to any of the preceding claims, characterized in that at least the aforementioned portion (6) is formed of a layer-shaped material or layer of material (11).

8. Variable optical filter according to claim 7, characterized in that the entire filter structure (2), in other words, at least the aforementioned zones (3A-3B-3C-3D-3E), are formed in the material layer (11).

9. Variable optical filter according to claim 7 or 8, characterized in that the aforementioned material layer (11) is provided on a support layer (12), either or not with the intermediate of additional layers (13-14) provided in between.

10. Variable optical filter according to claim 9, characterized in that between the aforementioned material layer (11) and the support layer (12), an underlayer (13) is present consisting of a polymer which provides in the improvement of the light conduction.

11. Variable optical filter according to any of the claims 7 to 10, characterized in that on the aforementioned material layer (11), a top layer (14) is provided which offers an optical screening.

12. Variable optical filter according to any of the claims 7 to 11, characterized in that, on one hand, at least the aforementioned material layer (11) and, on the other hand, possibly additional layers (13-14) provided on top thereof or beneath thereof are formed by so-called spincoating.

13. Variable optical filter according to any of the claims 7 to 12, characterized in that the filter (1) is provided with an optical entry part (15), as well as an optical exit part (16), allowing a connection to optical fibers (17-18).

14. Variable optical filter according to any of the preceding claims, characterized in that it is provided with a casing (19) and/or cooling means in order to limit temperature influences in the filter structure (2).

15. Variable optical filter according to any of the preceding claims, characterized in that the aforementioned portion (6) comprises one or more polymers having the feature that the refractive index changes in function of the control, more particularly in function of the electric field, linearly or almost linearly.

16. Variable optical filter according to any of the preceding claims, characterized in that the aforementioned portion (6) comprises one or more oriented polymers.

17. Device applying a variable optical filter according to any of the claims 1 to 16, characterized in that the device consists of a multiplexer and/or demultiplexer for optical signals.

18. Device applying a variable optical filter according to any of the claims 1 to 16, characterized in that the device consists of an optical signal generator.

19. Device according to claim 17 or 18, characterized in that it forms a part of a transmission structure for telecommunications or a transmission system for applications in domotics and immotics.
